(19) United States
(12) Patent Application Publication
(10) Pub. No.: US 2010/0118004 A1
(43) Pub. Date: May 13, 2010

(54) PLASMA DISPLAY DEVICE

(76) Inventors: Mitsuhiro Murata, Hyogo (JP); Takuji Tsujita, Osaka (JP); Toshikazu Wakabayashi, Osaka (JP); Hiroshi Asano, Osaka (JP); Masaharu Terauchi, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/597,803

(22) PCT Filed: Apr. 14, 2009
(86) PCT No.: PCT/JP2009/001705

§ 371 Date: Oct. 27, 2009

(30) Foreign Application Priority Data
Apr. 18, 2008 (JP) 2008-108597

(51) Int. Cl. G09G 3/28; G06F 3/038

(52) U.S. Cl. 345/205; 345/60

(57) ABSTRACT

A protective layer of a plasma display panel has a base protective layer formed of a thin film of a metal oxide, and a particle layer. The particle layer is formed by sticking, to the base protective layer, single-crystal particles of magnesium oxide such that the emission intensity of a peak at 200 nm to 300 nm is at least twice the emission intensity of a peak at 300 nm to 550 nm in an emission spectrum of cathode luminescence light emission. A panel driving circuit drives the panel in a manner that a second subfield group having a plurality of subfields is temporally disposed after a first subfield group having a plurality of subfields to form one field period. Each subfield of the first subfield group has initializing period (Ti), address period (Tw) for forming wall charge to cause a sustain discharge, and sustain period (Ts). Each subfield of the second subfield group has address period (Tw) for erasing wall charge necessary for causing a sustain discharge, and sustain period (Ts).

### TECHNICAL FIELD

The present invention relates to a plasma display device, which is an image display device using a plasma display panel.

### BACKGROUND ART

Among thin-type image display devices, a plasma display panel (hereinafter simply referred to as “panel”) allows high-speed display and can be easily upsized. Thus a plasma display panel is commercialized as a large-screen image display device.

The panel is formed of a front plate and a back plate bonded together. The front plate has the following elements:
a glass substrate;
display electrode pairs, each formed of a scan electrode and a sustain electrode, disposed on the glass substrate;
a dielectric layer formed to cover the display electrode pairs; and a protective layer formed on the dielectric layer.
   The protective layer is disposed to protect the dielectric layer from ion collision and to facilitate generation of discharge.

The back plate has the following elements:
a glass substrate;
data electrodes formed on the glass substrate;
a dielectric layer covering the data electrodes;
barrier ribs formed on the dielectric layer; and
phosphor layers formed between the barrier ribs and emitting light of red, green, and blue colors.
   The front plate and the back plate are faced to each other so that the display electrode pairs and the data electrodes intersect with each other and sandwich a discharge space between the electrodes. The peripheries of the plates are sealed with a low-melting glass. A discharge gas containing xenon is sealed into the discharge space. Discharge cells are formed in parts where the display electrode pairs are faced to the data electrodes.

In a plasma display device having a panel structured as above, a gas discharge is caused selectively in the respective discharge cells of the panel, and the ultraviolet light generated at this time excites the red, green, and blue phosphors so that light is emitted for color display.

A subfield method is typically used as a method for displaying images in a plasma display device using such a panel. In this method, one field period is formed of a plurality of subfields that have predetermined luminance weights, and light emission and no light emission of discharge cells are controlled in each subfield for image display.

However, it is known that, when each discharge cell is lit or unlit optionally in each subfield, pronounced variations in gradation in a contour shape, so-called false contours occur during the display of dynamic images. Then, a method for suppressing such false contours is proposed (see Patent Literature 1, for example). In this method, in order to suppress false contours, control is made for gradation display so that subfields in which the discharge cells are lit are successively disposed, and the subfields in which the discharge cells are unlit are also successively disposed. Although such a display method can suppress occurrence of false contours, displayable gradation is limited and displaying smooth gradation is difficult.

In order to display smooth gradation, it is only necessary to increase the number of subfields forming one field period. In the above subfield method, one field period is formed of a plurality of subfields each having an initializing period, an address period, and a sustain period, and the combination of subfields of light emission provides gradation display. In order to increase the number of subfields forming one field period, reliable address operation needs to be performed within a short period of time. For this purpose, development of a panel that can be driven at high speed is promoted. Studies are also proceeding on a driving method and a driving circuit for displaying high quality images by taking full advantage of the panel.

The discharge characteristics of a panel depend largely on the characteristics of its protective layer. Particularly, in order to improve electron emission performance and charge retention performance that have considerable influence on whether or not the panel can be driven at high speed, many studies are made on the materials, structures, and manufacturing methods of the protective layer. For example, Patent Literature 2 discloses a plasma display device that has a panel and an electrode driving circuit. In this plasma display device, the panel includes a magnesium oxide layer that is made from magnesium vapor by gas-phase oxidation and has a cathode luminescence light emission peak at 200 nm to 300 nm. In address periods, the electrode driving circuit sequentially applies a scan pulse to one electrode of each one of display electrode pairs constituting the all display lines, and supplies, to the data electrodes, an address pulse that corresponds to the display lines applied with the scan pulse.

In recent years, a plasma display device having high definition as well as a large screen has been demanded. Further, high image display quality has been demanded. While the number of lines is increased as described above, the number of subfields for displaying smooth gradation needs to be secured. Thus the time assigned for the address operation per line tends to be further shortened. Therefore, in order to perform a reliable address operation within the assigned time, there is a demand for a panel capable of performing more stable address operation at higher speed than those of conventional arts, a driving method for the panel, and a plasma display device that has a driving circuit for implementing the method.

[Patent Literature 1] Japanese Patent Unexamined Publication No. 1111-305726

[Patent Literature 2] Japanese Patent Unexamined Publication No. 2006-54158

### SUMMARY OF THE INVENTION

A plasma display device has a panel and a panel driving circuit. The panel has a front plate and a back plate faced to each other. The front plate has display electrode pairs formed on a first glass substrate, a dielectric layer formed to cover the display electrode pairs, and a protective layer formed on the dielectric layer. The back plate has data electrodes formed on a second glass substrate. Discharge cells are formed in positions where the display electrode pairs are faced to the data electrodes. The panel driving circuit drives the panel in a manner that a plurality of subfields are temporally disposed to form one field period. The protective layer has a base protective layer and a particle layer. The base protective layer is formed of a thin film of a metal oxide containing at least one of magnesium oxide, strontium oxide, calcium oxide, and barium oxide. The particle layer is formed by sticking, to the base protective layer, single-crystal particles of magnesium oxide such that the emission intensity of a peak at 200 nm to 300 nm is at least twice the emission intensity of a peak at 300 nm to 550 nm in an emission spectrum of cathode luminescence light emission. The panel driving circuit drives the panel in a manner that a second subfield group having a plurality of subfields is temporally disposed after a first subfield group having a plurality of subfields to form one field period. Each of the subfields in the first subfield group has an initializing period for forming wall charge to cause an address discharge, an address period for forming wall charge to cause a sustain discharge, and a sustain period for causing a sustain discharge to light the discharge cells. Each of the subfields in the second subfield group has an address period for erasing wall charge necessary for causing a sustain discharge, and a sustain period for causing a sustain discharge to light the discharge cells.

### BRIEF DESCRIPTION OF THE DRAWINGS

FIG. 1 is a perspective view showing a structure of a panel in accordance with an exemplary embodiment of the present invention.

FIG. 2 is a sectional view showing a structure of a front plate of the panel.

FIG. 3 is a diagram showing an emission spectrum of a single-crystal particle for use in the panel.

FIG. 4 is a graph showing the relation between a peak ratio of an emission spectrum of the single-crystal particle for use in the panel and a discharge delay time.

FIG. 5 is a diagram showing an electrode array of the panel.

FIG. 6 is a waveform chart of driving voltages to be applied to respective electrodes of the panel.

FIG. 7 is a waveform chart of driving voltages to be applied to the respective electrodes of the panel.

FIG. 8 is a circuit block diagram of a plasma display device in accordance with the exemplary embodiment of the present invention.

FIG. 9 is a circuit diagram of a scan electrode driving circuit and a sustain electrode driving circuit of the plasma display device.

### REFERENCE MARKS IN THE DRAWINGS

10 Panel
20 Front plate
21 (First) glass substrate
22 Scan electrode
22a, 23a Transparent electrode
22b, 23b Bus electrode
23 Sustain electrode
24 Display electrode pair
25 Dielectric layer
26 Protective layer
26a Base protective layer
26b Particle layer
27 Single-crystal particle
30 Back plate
31 (Second) glass substrate
32 Data electrode
34 Barrier rib
35 Phosphor layer
41 Image signal processing circuit
42 Data electrode driving circuit
43 Scan electrode driving circuit
44 Sustain electrode driving circuit
45 Timing generating circuit
50, 80 Sustain pulse generating circuit
60 Initializing waveform generating circuit
70 Scan pulse generating circuit
100 Plasma display device

### DETAILED DESCRIPTION OF PREFERRED EMBODIMENT

A plasma display device in accordance with an exemplary embodiment of the present invention is demonstrated hereinafter with reference to the accompanying drawings.

### Exemplary Embodiment

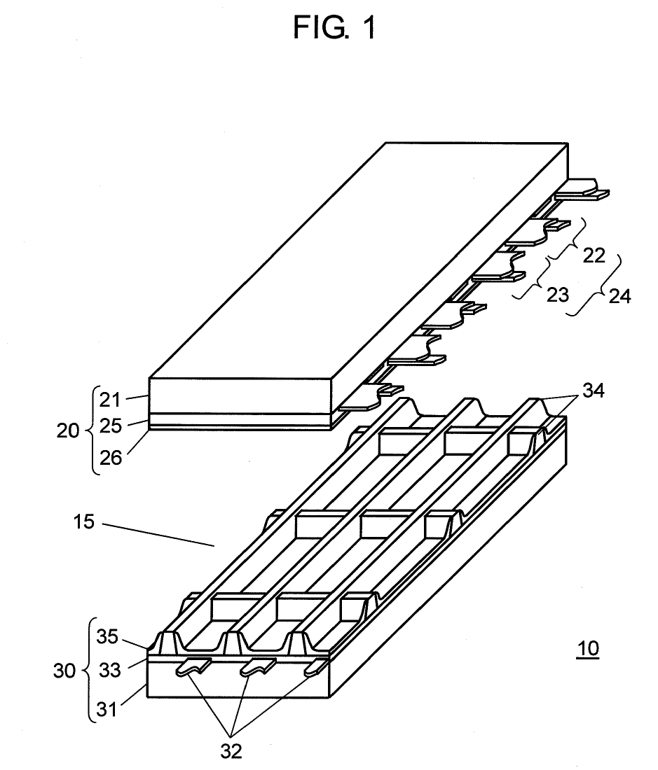

FIG. 1 is a perspective view showing a structure of panel 10 in accordance with the exemplary embodiment of the present invention. In panel 10, front plate 20 and back plate 30 are faced to each other, and the outer peripheries of the plates are sealed with a sealing material, a low-melting glass. A discharge gas containing xenon, or the like, is sealed into discharge space 15 inside of panel 10 at a pressure in the range of 400 Torr to 600 Torr.

A plurality of display electrode pairs 24, each formed of scan electrode 22 and sustain electrode 23, are formed parallel to each other on glass substrate (first glass substrate) 21 of front plate 20. Dielectric layer 25 is formed on glass substrate 21 so as to cover display electrode pairs 24. Further, protective layer 26 predominantly composed of magnesium oxide is formed on dielectric layer 25.

A plurality of data electrodes 32 are formed on glass substrate (second glass substrate) 31 of back plate 30 so as to be parallel to each other in the direction orthogonal to display electrode pairs 24. Dielectric layer 33 covers the data electrodes. Further, barrier ribs 34 are formed on dielectric layer 33. Phosphor layers 35 caused to emit red, green, or blue light by ultraviolet light are formed on dielectric layer 33 and the side faces of barrier ribs 34. A discharge cell is formed in a position where display electrode pair 24 intersects with data electrode 32. A set of discharge cells having red, green, and blue phosphor layers 35 forms a pixel for color display. Dielectric layer 33 is not essential, and may be omitted from the structure of the panel.

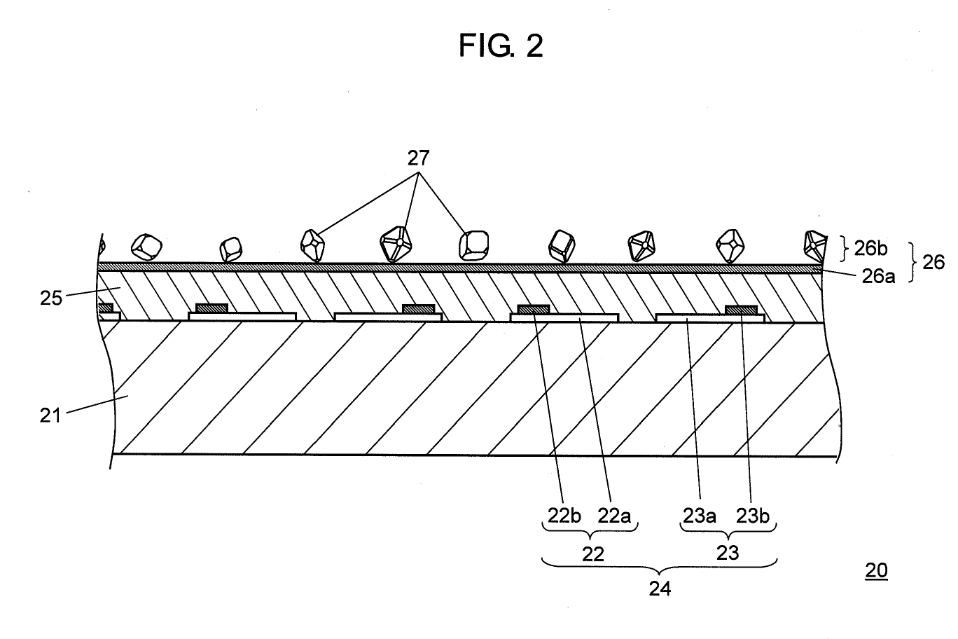

FIG. 2 is a sectional view showing a structure of front plate 20 of panel 10 in accordance with the exemplary embodiment of the present invention. In FIG. 2, front plate 20 of FIG. 1 is vertically inverted. Display electrode pairs 24, each formed of scan electrode 22 and sustain electrode 23, are formed on glass substrate 21. Each scan electrode 22 is formed of transparent electrode 22a composed of indium tin oxide, tin oxide, or the like, and bus electrode 22b disposed on transparent electrode 22a. Similarly, each sustain electrode 23 is formed of transparent electrode 23a, and bus electrode 23b disposed on the transparent electrode. Bus electrodes 22b and bus electrodes 23b are disposed to impart conductivity in the longitudinal direction of respective transparent electrodes 22a and transparent electrodes 23a, and are formed of a conductive material predominantly composed of silver.

Dielectric layer 25 is formed by applying, for example, a low-melting glass predominantly composed of lead oxide, bismuth oxide, or phosphorous oxide by screen printing, die coating, or other methods, and firing the glass. Protective layer 26 is formed on dielectric layer 25.

Protective layer 26 is formed on dielectric layer 25. Protective layer 26 is detailed hereinafter. The protective layer protects dielectric layer 25 from ion collision, and improves electron emission performance and charge retention performance that have considerable influence on driving speed. For this purpose, protective layer 26 has base protective layer 26a formed on dielectric layer 25, and particle layer 26b formed on base protective layer 26a.

Base protective layer 26a is a thin film of magnesium oxide that is formed by sputtering, ion plating, electron beam evaporation, or other methods, and has a thickness in the range of 0.3 μm to 1 μm.

Particle layer 26b is formed by sticking, to base protective layer 26a, single-crystal particles 27 of magnesium oxide that are made by firing a magnesium oxide precursor and have a relatively uniform particle-size distribution with an average particle diameter in the range of 0.3 μm to 4 μm. Single-crystal particles 27 do not need to cover the entire surface of base protective layer 26a, and only need to be formed in an island shape having a covering ratio of 1% to 30% on base protective layer 26a. Single-crystal particles 27 are basically shaped into a regular hexahedron or a regular octahedron. However, slight deformation caused by variations in production is allowed. The single-crystal particles may be shaped to have truncated faces and rhombic faces formed by cutting vertexes and ridge lines, respectively, in the regular hexahedron or regular octahedron shape.

In this manner, protective layer 26 is made of base protective layer 26a, and particle layer 26b formed on base protective layer 26a. With this structure, panel 10 that has protective layer 26 exhibiting high electron emission performance and high charge retention performance can be provided.

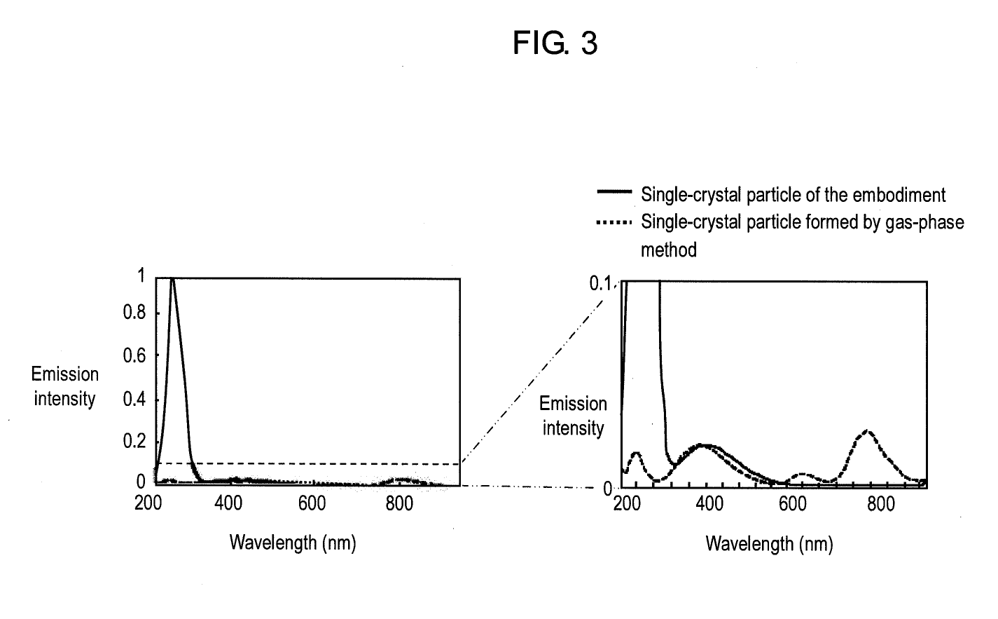

Examining cathode luminescence light emission of a single-crystal particle, the inventors have found that the characteristics, particularly electron emission performance, of the single-crystal particle can be evaluated from an emission spectrum thereof. FIG. 3 is a diagram showing an emission spectrum of single-crystal particle 27 for use in the panel in accordance with the exemplary embodiment of the present invention. For comparison, FIG. 3 also shows an emission spectrum of a single-crystal particle of magnesium oxide formed on the base protective layer by a gas-phase oxidation method. The emission spectrum of single-crystal particle 27 of the exemplary embodiment has a large peak of emission intensity at 200 nm to 300 nm, and a small peak at 300 nm to 550 nm. On the other hand, in the emission spectrum of the single-crystal particle formed by the gas-phase oxidation method, the peak of emission intensity at 200 nm to 300 nm and the peak of emission intensity at 300 nm to 550 nm are both small.

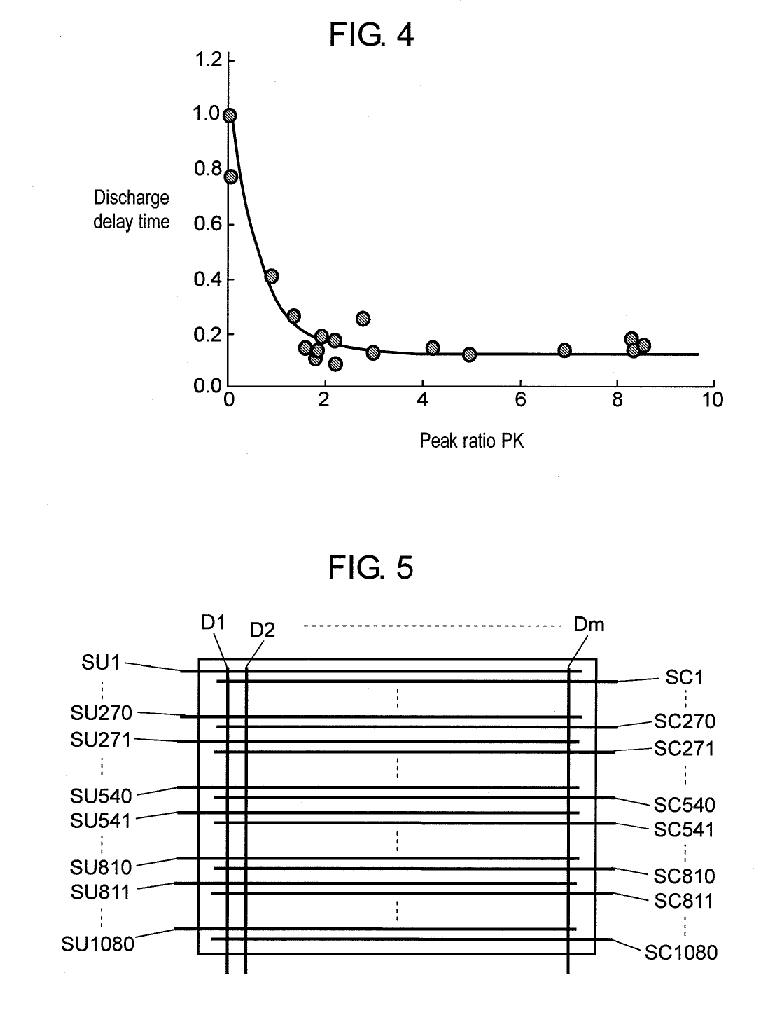

Focusing on these two peaks of emission intensity, the inventors have examined the relation between the ratio of the emission intensity of a peak at 200 nm to 300 nm to the emission intensity of a peak at 300 nm to 550 nm (hereinafter simply referred to as “peak ratio PK”), and electron emission performance. For this purpose, the inventors have fabricated trial panels having different values of peak ratio PK and measured a discharge delay time for each panel. FIG. 4 is a graph showing the relation of peak ratio PK of an emission spectrum of single-crystal particle 27 for use in the panel of the exemplary embodiment and discharge delay time Td. The horizontal axis represents peak ratio PK, which is determined by calculating a ratio of the integration value of an emission spectrum in the range of 200 nm or larger and smaller than 300 nm and the integration value of the emission spectrum in the range of 300 nm or larger and smaller than 550 nm. The vertical axis represents a discharge delay time, as value TS, which is a normalized value with respect to the discharge delay time exhibited when peak ratio PK is approximately zero. That is, a panel exhibiting smaller value TS has higher electron emission performance. As shown in the graph, when peak ratio PK of the emission spectrum is at least 2, i.e. when the emission intensity of a peak at 200 nm to 300 nm is at least twice the emission intensity of a peak at 300 nm to 550 nm, normalized discharge delay time TS is kept substantially constant at 0.2 or smaller, which shows excellent electron emission performance.

Though not clarified completely, the relation between peak ratio PK of the emission spectrum and electron emission performance can be considered as follows. The peak of the emission spectrum at 200 nm to 300 nm shows the presence of relaxation process of an energy of approximately 5 eV. This peak also suggests a high probability of Auger electron emission caused by relaxation of this large amount of energy. On the other hand, the peak of the emission spectrum at 300 nm to 550 nm shows the presence of a large number of trap levels between band gaps, which are caused by an oxygen defect, for example. This peak suggests that the relaxation process of a large amount of energy is difficult to occur and thus there is a low probability of Auger electron emission. Therefore, when the peak at 200 nm to 300 nm is larger and the peak at 300 nm to 500 nm is smaller, electrons are more easily emitted. Thus particle layer 26b formed of single-crystal particles 27 having such characteristics allows a panel to have high electron emission performance.

The above single-crystal particle 27 that has a large peak at 200 nm to 300 nm and a small peak at 300 nm to 550 nm in an emission spectrum can be produced by liquid phase methods.

Specifically, for example, such single crystal particles can be produced by evenly firing magnesium hydroxide, i.e. a precursor of magnesium oxide, in an oxygen-containing atmosphere at high temperatures, as described below.

### (Liquid Phase Method 1)

A small amount of acid is added to an aqueous solution of magnesium alkoxide or magnesium acetylacetone at a purity of 99.95% or higher. Thereby, the solution is hydrolyzed, so that a gel of magnesium hydroxide is prepared. The gel is fired in the air for dehydration. Thus the powder of single-crystal particles 27 is produced.

### (Liquid Phase Method 2)

An alkaline solution is added to an aqueous solution of magnesium nitrate at a purity of 99.95% or higher, to precipitate magnesium hydroxide. Next, the precipitate of magnesium hydroxide is separated from the aqueous solution, and fired in the air for dehydration. Thus the powder of single-crystal particles 27 is produced.

### (Liquid Phase Method 3)

Calcium hydroxide is added to an aqueous solution of magnesium chloride at a purity of 99.95% or higher, to precipitate magnesium hydroxide. Next, the precipitate of magnesium hydroxide is separated from the aqueous solution, and fired in the air for dehydration. Thus the powder of single-crystal particles 27 is produced.

Preferably, the firing temperature is 700° C. or higher; and more preferably, 1000° C. or higher. This is because the crystal faces grow insufficiently and have many defects, at firing temperatures lower than 700° C.

The experimental results of the inventors show that two types of single-crystal particle are produced at firing temperatures of 700° C. or higher and lower than 2000° C. One is a single-crystal particle that has a peak ratio PK equal to or larger than 1; the other is a single-crystal particle that has a peak ratio PK smaller than 1 and has a peak at a considerable level in the spectrum range of 680 nm to 900 nm. The experimental results also show that single-crystal particles having a peak ratio PK smaller than 1 and a peak in the emission spectrum range of 680 nm to 900 nm are produced at a higher rate, at firing temperatures of 1400° C. or higher. Therefore, in order to raise the rate of the magnesium oxide single-crystal having a peak ratio PK equal to or larger than 1, it is preferable to set the firing temperature to 700° C. or higher and lower than 1,400° C.

The usable magnesium oxide precursors other than the above magnesium hydroxide include magnesium alkoxide, magnesium acetylacetone, magnesium nitrate, magnesium chloride, magnesium carbonate, magnesium sulfate, magnesium oxalate, and magnesium acetate. At least one of these magnesium compounds can be used. Preferably, the purity of the magnesium compound as a magnesium oxide precursor is 99.95% or higher; more preferably, 99.98% or higher. This is because when more impurity elements, e.g. alkali metal, boron, silicon, iron, and aluminum, are contained, particles fuse or sinter each other during firing, and thus highly-crystalline particles are difficult to grow.

The magnesium oxide single-crystal that has a peak ratio PK smaller than 1 and a peak in the spectrum range of 680 nm to 900 nm tends to be smaller in diameter than a magnesium oxide single-crystal having a peak ratio PK equal to or larger than 1. Therefore, these two types of magnesium oxide single-crystal can be separated by classification, so that single-crystal particles having a larger peak ratio PK can be selected.

In this manner, particle layer 26b of the exemplary embodiment is formed by sticking, to base protective layer 26a, single-crystal particles 27 such that the ratio of a peak at 200 nm to 300 nm to a peak at 300 nm to 550 nm in an emission spectrum is at least 2. This structure allows a panel to have stably high electron emission performance and charge retention performance, and to be driven at high speed.

Next, a description is provided for a driving method of panel 10 in accordance with the exemplary embodiment of the present invention.

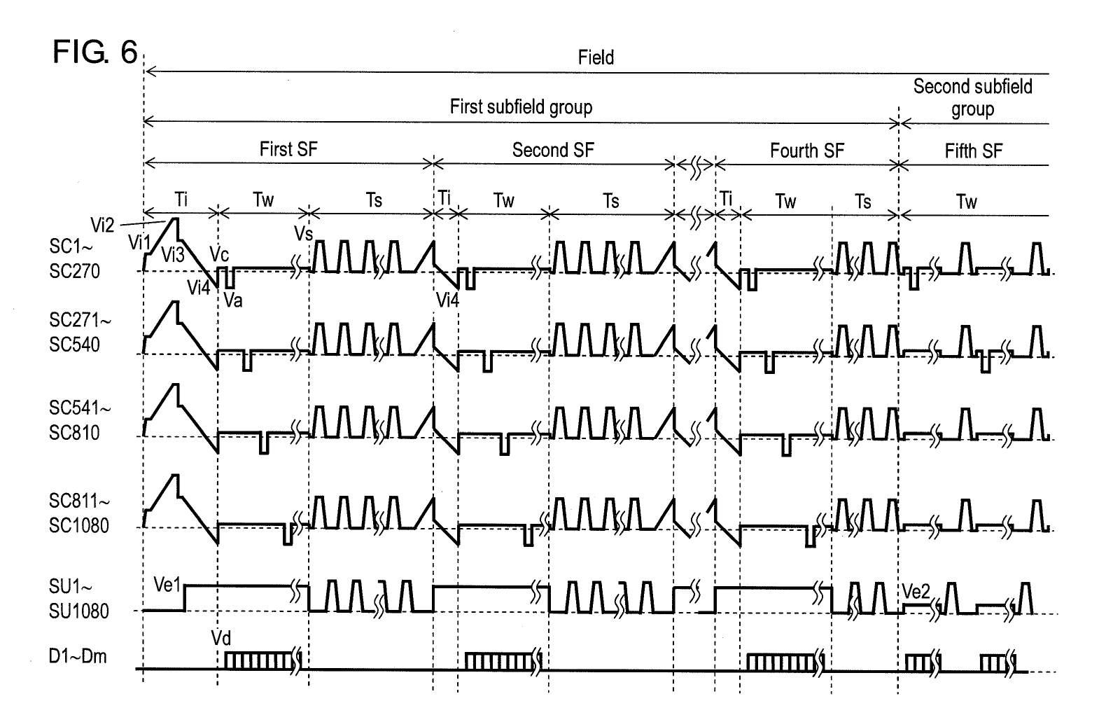

FIG. 5 is a diagram showing an electrode array of panel 10 in accordance with the exemplary embodiment of the present invention. Panel 10 has n scan electrodes SC1 through SCn (scan electrodes 22 in FIG. 1) and n sustain electrodes SU1 through SUn (sustain electrodes 23 in FIG. 1) both long in the row (line) direction, and m data electrodes D1 through Dm (data electrodes 32 in FIG. 1) long in the column direction. A discharge cell is formed in the part where a pair of scan electrode SCi (i is 1 through n) and sustain electrode SUi intersects with one data electrode Dj (j is 1 through m). Thus m×n discharge cells are formed in the discharge space. For example, the number of discharge cells is represented by the following values:

m=1920×3=5760, and n=1080

The number of display electrode pairs is not specifically limited. In this exemplary embodiment, description is provided for n=1080.

Further, scan electrodes SC1 through SC1080 and sustain electrodes SU1 through SU1080 form 1080 display electrode pairs. These display electrode pairs are divided into a plurality of display electrode pair groups. In the exemplary embodiment, the panel is divided into four groups of display electrode pairs in the direction from top to bottom of the panel. The four groups are referred to as a first display electrode pair group, a second display electrode pair group, a third display electrode pair group, and a fourth display electrode pair group in the order starting from the display electrode pair disposed at the top of the panel. That is, scan electrodes SC1 through SC270 and sustain electrodes SU1 through SU270 belong to the first display electrode pair group. Scan electrodes SC271 through SC540 and sustain electrodes SU271 through SU540 belong to the second display electrode pair group. Scan electrodes SC541 through SC810 and sustain electrodes SU541 through SU810 belong to the third display electrode pair group. Scan electrodes SC811 through SC1080 and sustain electrodes SU811 through SU1080 belong to the fourth display electrode pair group.

Next, a description is provided for driving waveform voltages to be applied to the respective electrodes to drive panel 10. Panel 10 is driven by a subfield method in which a plurality of subfields are temporally disposed to form one field period. That is, one field period is divided into a plurality of subfields, and light emission and no light emission of each discharge cell are controlled in each subfield for gradation display. In the exemplary embodiment, panel 10 is driven in a manner that the plurality of subfields are divided into a first subfield group and a second subfield group.

Each subfield belonging to the first subfield group has an initializing period, an address period, and a sustain period. In the initializing period, an initializing discharge is caused to erase the history of wall charge in the discharge cells and form wall charge for causing an address discharge. In the address period, an address discharge is caused to form wall charge for causing a sustain discharge in the discharge cells to be lit. Such an address operation is referred to as “positive-logic addressing” hereinafter. In the sustain period, sustain pulses corresponding in number to the luminance weight are applied alternately to display electrode pairs to cause a sustain discharge for light emission in the discharge cells having undergone positive-logic addressing.

In the subfields belonging to the first subfield group, the address discharge in each subfield is controlled so that the discharge cells can be lit or unlit independently of whether or not a sustain discharge is caused in other subfields. The driving in which light emission and no light emission is independently controlled in each subfield in this manner is referred to as “random driving” hereinafter.

On the other hand, each subfield belonging to the second subfield group has no initializing period, and has an address period and a sustain period. In the address period, an address discharge is caused in the discharge cells to be unlit, to erase the wall charge necessary for causing a sustain discharge. Such an address operation is referred to as “negative-logic addressing”. In the sustain period, sustain pulses corresponding in number to the luminance weight are applied alternately to the display electrode pairs, to cause a sustain discharge for light emission in the discharge cells having undergone no address discharge.

In each subfield belonging to the second subfield group, an operation for forming wall charge necessary for causing a sustain discharge is not performed. Instead, in the address period, an operation for erasing the wall charge necessary for causing a sustain discharge is performed. Therefore, in the discharge cells having undergone no sustain discharge in the immediately preceding subfield, no sustain discharge is caused until the next initializing operation is performed. In the discharge cells having undergone an address operation once, no sustain discharge is caused until the next initializing operation is performed.

As a result, in the subfields belonging to the second subfield group, subfields (SFs) in which discharge cells are lit are successively disposed, and those in which discharge cells are unlit are also successively disposed. Such a driving method for gradation display by controlling so that light emission and no light emission of discharge cells are successively performed is referred to as “successive driving” hereinafter.

In the exemplary embodiment, one field is divided into 11 subfields (the first SF, and the second SF through the 11th SF). The respective subfields have luminance weights of 8, 4, 2, 1, 16, 20, 26, 32, 40, 48, and 58 in this order. The first SF through the fourth SF forms the first subfield group in which random driving is performed using positive-logic addressing. The fifth SF through the 11th SF forms the second subfield group in which successive driving is performed using negative-logic addressing. In the initializing period of the first SF belonging to the first subfield group, an all-cell initializing operation for causing an initializing discharge in all the discharge cells is performed. In the initializing periods of the second SF through the fourth SF belonging to the same group, a selective initializing operation for causing an initializing discharge selectively in the discharge cells having undergone a sustain discharge in the immediately preceding subfield is performed.

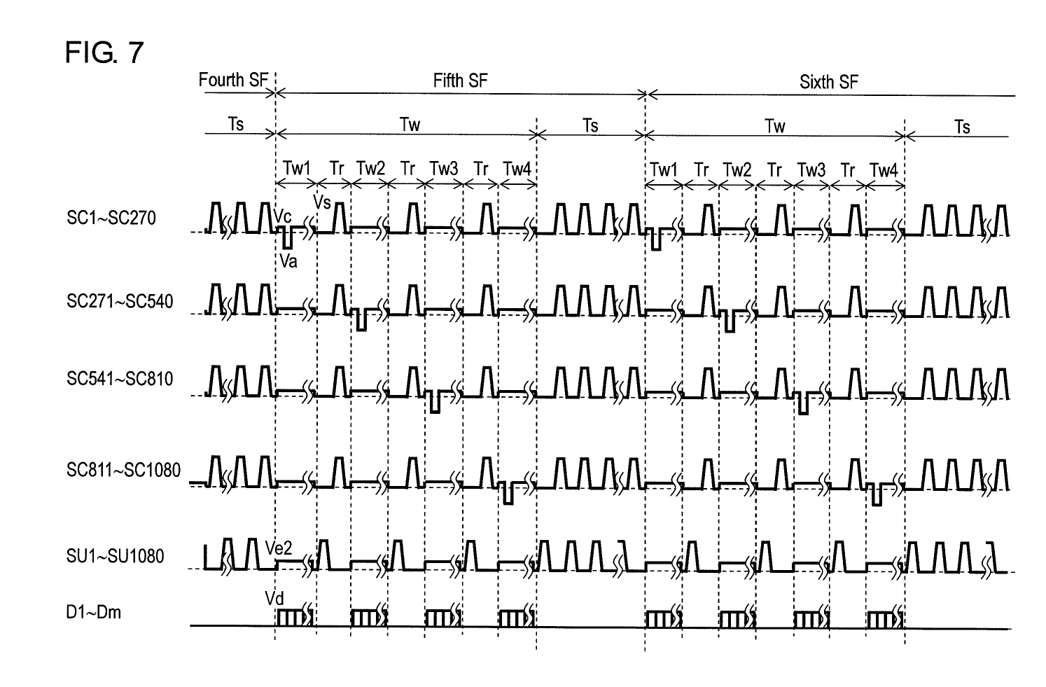

Hereinafter, a description is provided for a method for driving the panel of the exemplary embodiment. FIG. 6 and FIG. 7 are waveform charts of driving voltages to be applied to respective electrodes of panel 10 in accordance with the exemplary embodiment of the present invention. FIG. 6 mainly shows driving voltage waveforms in the first subfield group. FIG. 7 mainly shows driving voltage waveforms in the second subfield group.

First, a description is provided for driving voltage waveforms in the first subfield group.

In the first half of initializing period Ti of the first SF, 0 (V) is applied to each of data electrodes D1 through Dm and sustain electrodes SU1 through SUn, and a ramp waveform voltage is applied to scan electrodes SC1 through SCn. Here, the ramp waveform voltage gradually rises from voltage Vi1, which is equal to or lower than a discharge start voltage, toward voltage Vi2, which exceeds the discharge start voltage, with respect to sustain electrodes SU1 through SUn.

While this ramp waveform voltage is rising, a weak initializing discharge occurs between scan electrodes SC1 through SCn and sustain electrodes SU1 through SUn, and between the scan electrodes and data electrodes D1 through Din. Then, negative wall voltage accumulates on scan electrodes SC1 through SCn. Positive wall voltage accumulates on data electrodes D1 through Dm and sustain electrodes SU1 through SUn. Here, the wall voltages on the electrodes represent the voltages that are generated by wall charge accumulated on the dielectric layers covering the electrodes, the protective layer, and the phosphor layers, for example. In this initializing discharge, wall voltages are excessively accumulated prior to the subsequent latter half of initializing period Ti in which the wall voltages are optimized.

Next, in the latter half of initializing period Ti, voltage Ve1 is applied to sustain electrodes SU1 through SUn, and a ramp waveform voltage is applied to scan electrodes SC1 through SCn. Here, the ramp waveform voltage gradually falls from voltage Vi3, which is equal to or lower than the discharge start voltage, toward voltage Vi4, which exceeds the discharge start voltage, with respect to sustain electrodes SU1 through SUn. During this application, a weak initializing discharge occurs between scan electrodes SC1 through SCn and sustain electrodes SU1 through SUn, and between the scan electrodes and data electrodes D1 through Dm. This weak discharge reduces the negative wall voltage on scan electrodes SC1 through SCn, and the positive wall voltage on sustain electrodes SU1 through SUn, and adjusts the positive wall voltage on data electrodes D1 through Dm to a value appropriate for the address operation. In this manner, the all-cell initializing operation for causing the initializing discharge in all the discharge cells is completed.

In subsequent address period Tw, voltage Ve1 is applied to sustain electrodes SU1 through SUn, and voltage Vc is applied to scan electrodes SC1 through SCn.

Next, negative scan pulse voltage Va is applied to scan electrode SC1 in the first line. Positive address pulse voltage Vd is applied to data electrode Dk (k is 1 through m) of a discharge cell to be lit in the first line, among data electrodes D1 through Dm. At this time, the voltage difference in the intersecting part between data electrode Dk and scan electrode SC1 is obtained by adding the difference in an externally applied voltage (voltage Vd− voltage Va) to the difference between the wall voltage on data electrode Dk and the wall voltage on scan electrode SC1. Thus the voltage difference exceeds the discharge start voltage. Then, an address discharge occurs between data electrode Dk and scan electrode SC1, and between sustain electrode SU1 and scan electrode SC1. Positive wall voltage accumulates on scan electrode SC1 and negative wall voltage accumulates on sustain electrode SU1. Negative wall voltage also accumulates on data electrode Dk.

Here, the time after application of scan pulse voltage Va and address pulse voltage Vd until generation of an address discharge is referred to as “discharge delay time”. If a panel has low electron emission performance and thus a long discharge delay time, the time periods during which scan pulse voltage Va and address pulse voltage Vd are applied for a reliable address operation, i.e. a scan pulse width and an address pulse width, need to be set longer. Thus the address operation cannot be performed at high speed. If a panel has low charge retention performance, the values of scan pulse voltage Va and address pulse voltage Vd need to be set higher to compensate for a decrease in the wall voltages. However, because panel 10 of the exemplary embodiment has high electron emission performance, the scan pulse width and address pulse width can be set shorter than those of the conventional panel, and the address operation can be performed stably at high speed. Further, because panel 10 of the exemplary embodiment has high charge retention performance, the values of scan pulse voltage Va and address pulse voltage Vd can be set lower than those of the conventional panel.

In this manner, a positive-logic address operation is performed to cause the address discharge and to accumulate wall charge necessary for a sustain discharge in the discharge cells to be lit in the first line. On the other hand, the voltage in the intersecting parts between data electrodes D1 through Dm applied with no address pulse voltage Vd and scan electrode SC1 does not exceed the discharge start voltage, so that no address discharge occurs. The above positive-logic address operation is repeated until the operation reaches the discharge cells in the n-th line, and address period Tw is completed.

In subsequent sustain period Ts, first, positive sustain pulse voltage Vs is applied to scan electrodes SC1 through SCn, and 0 (V) is applied to sustain electrodes SU1 through SUn. Then, in the discharge cells having undergone the positive-logic addressing, the voltage difference between scan electrode SCi and sustain electrode SUi is obtained by adding sustain pulse voltage Vs to the difference between the wall voltage on scan electrode SCi and the wall voltage on sustain electrode SUi. Thus the voltage difference exceeds the discharge start voltage.

Then, a sustain discharge occurs between scan electrode SCi and sustain electrode SUi, and ultraviolet light generated at this time causes phosphor layers 35 to emit light. Negative wall voltage accumulates on scan electrode SCi, and positive wall voltage accumulates on sustain electrode SUi. Positive wall voltage also accumulates on data electrode Dk. In the discharge cells having undergone no positive-logic addressing in address period Tw, no sustain discharge occurs, and the wall voltage at the completion of initializing period Ti is maintained.

Subsequently, 0 (V) is applied to scan electrodes SC1 through SCn, and sustain pulse voltage Vs is applied to sustain electrodes SU1 through SUn. In the discharge cell having undergone the sustain discharge, the voltage difference between sustain electrode SUi and scan electrode SCi exceeds the discharge start voltage, so that a sustain discharge is caused between sustain electrode SUi and scan electrode SCi again. Negative wall voltage accumulates on sustain electrode SUi, and positive wall voltage accumulates on scan electrode SCi. Similarly, sustain pulses corresponding in number to the luminance weight are applied alternately to scan electrodes SC1 through SCn and sustain electrodes SU1 through SUn to cause a potential difference between the electrodes of each display electrode pair. Thereby, the sustain discharge is continued in the discharge cells having undergone the positive-logic addressing.

At the end of sustain period Ts, an up-ramp waveform voltage is applied to scan electrodes SC1 through SCn. Thereby, while the positive wall voltage is left on data electrode Dk, the wall voltages on scan electrode SCi and sustain electrode SUi are erased.

In initializing period Ti of subsequent second SF, voltage Ve1 is applied to sustain electrodes SU1 through SUn, 0 (V) is applied to data electrodes D1 through Dm, and a down-ramp voltage gradually falling toward voltage Vi4 is applied to scan electrode SC1 through SCn. In the discharge cells having undergone a sustain discharge in the immediately preceding subfield, a weak initializing discharge occurs and reduces the wall voltages on scan electrode SCi and sustain electrode SUi. On data electrode Dk, sufficient positive wall voltage is accumulated by the immediately preceding sustain discharge. Thus the excess part of the wall voltage is discharged, and the wall voltage is adjusted to a value appropriate for the address operation.

On the other hand, in the discharge cells having undergone no sustain discharge in the immediately preceding subfield, no discharge occurs, and the wall charge at the completion of the initializing period of the preceding subfield is maintained. In this manner, the initializing operation in the second SF is a selective initializing operation for causing a selective initializing discharge selectively in the discharge cells having undergone a sustain operation in the sustain period of the immediately preceding subfield.

The operation in the subsequent address period Tw is similar to the operation in address period Tw of the first SF, and the description thereof is omitted. The operation in the subsequent sustain period Ts is similar to the operation in sustain period Ts of the first SF, except for the number of sustain pulses. The operation in the subsequent third SF is similar to the operation in the second SF, except for the number of sustain pulses. Further, the operations in initializing period Ti and in address period Tw of the fourth SF are similar to those of the second SF.

In sustain period Ts of the fourth SF, in a similar manner to sustain periods Ts of the first SF through the third SF, sustain pulses corresponding in number to the luminance weight are applied alternately to scan electrodes SC1 through SCn and sustain electrodes SU1 through SUn, to cause a potential difference between the electrodes of each display electrode pair. Thereby, the sustain discharge is continued in the discharge cells having undergone positive-logic addressing.

At the end of sustain period Ts of the fourth SF, sustain pulse voltage Vs is applied to sustain electrodes SC1 through SCn, and 0 (V) is applied to sustain electrodes SU1 through SUn. Thereby, a sustain discharge is caused in the discharge cells having undergone an address discharge. With negative wall voltage accumulated on scan electrode SCi, positive wall voltage on sustain electrode SUi, and positive wall voltage also on data electrode Dk, sustain period Ts of the fourth SF is completed.

In this manner, in sustain period Ts of the last subfield in the first subfield group, the wall voltages on sustain electrode SCi and sustain electrode SUi are not erased. With negative wall voltage accumulated on scan electrode SCi and positive wall voltage on sustain electrode SUi, sustain period Ts is completed. These wall voltages are used for causing a sustain discharge in the subfields in the subsequent second subfield group.

On the other hand, in the discharge cells having undergone no sustain discharge in the fourth SF, no wall voltage is accumulated on scan electrode SCi and sustain electrode SUi. For this reason, in the discharge cells having undergone no sustain discharge in the fourth SF, no sustain discharge occurs in the fifth SF through the 11th SF in the subsequent second subfield group.

Next, a description is provided for driving voltage waveforms in the subfields belonging to the second subfield group, with reference to FIG. 7. In each subfield belonging to the second subfield group, address period Tw is divided into four address sub-periods (first sub-period Tw1, second sub-period Tw2, third sub-period Tw3, and fourth sub-period Tw4) corresponding to the four display electrode pair groups. Between each address sub-period and the next address sub-period, replenish sub-period Tr for replenishing wall charge is disposed.

In first sub-period Tw1 in address period Tw of the fifth SF, voltage Ve2 is applied to sustain electrodes SU1 through SUn, and voltage Vc is applied to scan electrodes SC1 through SCn. Next, scan pulse voltage Va is applied to scan electrode SC1 in the first line, and address pulse voltage Vd is applied to data electrode Dh (h is 1 through m) of a discharge cell to be unlit in the first line, among data electrodes D1 through Dm. Then, an address discharge occurs between data electrode Dh and scan electrode SC1, and between sustain electrode SU1 and scan electrode SC1. Thus the wall voltage on scan electrode SC1 and the wall voltage on sustain electrode SU1 are erased. Erasing the wall voltage means that the wall voltage is reduced to a level at which no sustain discharge occurs in the sustain period to be described later.

The above negative-logic addressing is repeated until the addressing reaches the discharge cells in the 270th line belonging to the first display electrode pair group. At this time, the discharge delay time in the negative-logic address operation is short, and thus the scan pulse width and the address pulse width can be set shorter than those of the conventional panel. Therefore, a stable address operation can be performed at high speed.

In subsequent replenish sub-period Tr, first, 0 (V) is applied to scan electrodes SC1 through SCn, and sustain pulse voltage Vs is applied to sustain electrodes SU1 through SUn. Then, in the discharge cells having undergone a sustain discharge in the immediately preceding fourth SF and having undergone no negative-logic addressing in first sub-period Tw1 of the fifth SF, a discharge occurs between scan electrode SCi and sustain electrode SUi. Such a discharge in replenish sub-period Tr (hereinafter referred to as “replenish discharge”) is similar to a sustain discharge. Positive wall charge is replenished on the data electrodes of the discharge cells having undergone a replenish discharge. Subsequently, sustain pulse voltage Vs is applied to scan electrodes SC1 through SCn, and 0 (V) is applied to sustain electrodes SU1 through SUn. Then, a replenish discharge occurs between scan electrode SCi and sustain electrode SUi again.

In subsequent second sub-period Tw2, a negative-logic address operation is performed on the discharge cells in the 271st line through 540th line belonging to the second display electrode pair group. In the subsequent replenish sub-period Tr, a replenish discharge is caused to replenish the wall charge on the data electrodes. In subsequent third sub-period Tw3, a negative-logic address operation is performed on the discharge cells in the 541st line through 810th line belonging to the third display electrode pair group. In the subsequent replenish sub-period Tr, a replenish discharge is caused to replenish the wall charge. In subsequent fourth sub-period Tw4, a negative-logic address operation is performed on the discharge cells in the 811th line through 1080th line belonging to the fourth display electrode pair group. With these operations, address sub-period Tw of the fifth SF is completed.

It has been verified that panel 10 of the exemplary embodiment has high charge retention performance, but the wall charge is decreased by negative-logic addressing. Assume the negative-logic address operation is successively performed on n lines without any replenish sub-period Tr disposed. In this case, the wall voltage decreases in response to the decrease in the wall charge, and thus voltages of scan pulse voltage Va and address pulse voltage Vd need to be increased. However, in the exemplary embodiment, replenish sub-period Tr for replenishing the wall charge on the data electrodes is disposed every time negative-logic addressing is performed on one-fourth of all the lines. This structure prevents the wall voltage from decreasing considerably, and allows the voltages of scan pulse voltage Va and address pulse voltage Vd to be set lower.

In subsequent sustain period Ts, first, 0 (V) is applied to scan electrodes SC1 through SCn, and positive sustain pulse voltage Vs is applied to sustain electrodes SU1 through SUn. In the discharge cell having undergone a sustain discharge in the immediately preceding subfield and having undergone no negative-logic addressing, a sustain discharge occurs to light the discharge cells. Positive wall voltage accumulates on scan electrode SCi, and negative wall voltage accumulates on sustain electrode SUi. On the other hand, in the discharge cells having undergone no sustain discharge in the immediately preceding subfield, or the discharge cells having undergone negative-logic addressing in the address period, no sustain discharge occurs.

Subsequently, sustain pulse voltage Vs is applied to scan electrodes SC1 through SCn, and 0 (V) is applied to sustain electrodes SU1 through SUn. In the discharge cell having undergone the sustain discharge, the voltage difference between scan electrode SCi and sustain electrode SUi exceeds the discharge start voltage, so that a sustain discharge is caused again. Negative wall voltage accumulates on scan electrode SCi, and positive wall voltage accumulates on sustain electrode SUi.

Similarly, sustain pulses corresponding in number to the luminance weight are applied alternately to sustain electrodes SU1 through SUn and scan electrodes SC1 through SCn to cause a potential difference between the electrodes of each display electrode pair. Thereby, the sustain discharge is continued in the discharge cells having undergone no address discharge in the address period.

The operations in the subsequent sixth SF through 11th SF are similar to those in the fifth SF, except for the numbers of sustain pulses.

In the exemplary embodiment, scan electrodes SC1 through SCn are applied with voltage Vi1 of 120 (V), voltage Vi2 of 350 (V), voltage Vi3 of 210 (V), voltage Vi4 of −105 (V), voltage Vc of 0 (V), voltage Va of −120 (V), and voltage Vs of 210 (V). Sustain electrodes SU1 through SUn are applied with voltage Ve1 of −140 (V), voltage Ve2 of 50 (V), and voltage Vs of 210 (V). Data electrodes D1 through Dm are applied with voltage Vd of 60 (V). The gradient of the up-ramp waveform voltage to be applied to scan electrodes SC1 through SCn is 1.0 V/μ, and the gradient of the down-ramp waveform voltage to be applied to the scan electrodes is −1.3V/μ. Each of the scan pulse and the address pulse has a pulse width of 1.0 μs. However, these voltages are not limited to the above values. It is preferable to set optimum values according to the discharge characteristics of the panel and the specifications of the plasma display device.

As described above, protective layer 26 of panel 10 of the exemplary embodiment has base protective layer 26a and particle layer 26b. The base protective layer is formed of a thin film of a metal oxide containing at least one of magnesium oxide, strontium oxide, calcium oxide, and barium oxide. The particle layer is formed by sticking, to base protective layer 26a, single-crystal particles 27 of magnesium oxide such that the ratio of a peak at 200 nm to 300 nm to a peak at 300 nm to 550 nm in an emission spectrum of cathode luminescence light emission is at least 2. With this structure, panel 10 has excellent electron emission performance and charge retention performance. The panel driving circuit divides a plurality of subfields forming one field period into two subfield groups and temporally disposes the second subfield group after the first subfield group. Each of the subfields belonging to the first subfield group has an initializing period for forming wall charge to cause an address discharge, an address period for forming wall charge to cause a sustain discharge, and a sustain period for causing a sustain discharge to light the discharge cells. In these subfields, random driving is performed using positive-logic addressing. Each of the subfields belonging to the second subfield group has an address period for erasing the wall charge necessary for a sustain discharge, and a sustain period for causing a sustain discharge to light the discharge cells. In these subfields, successive driving is performed using negative-logic addressing.

As described above, in the exemplary embodiment, by taking full advantage of panel 10 that has high electron emission performance and can be driven at high speed, the address period is shortened and the number of subfields in the second subfield group for successive driving can be secured. Thereby, image display without false contours is achieved. In combination with the first subfield group for random driving, smooth gradation display is achieved. Further, in each subfield belonging to the second subfield group, the address period is divided into a plurality of address sub-periods corresponding to a plurality of display electrode pair groups. A replenish sub-period for replenishing the wall charge is disposed between one of the address sub-periods and the next one of the address sub-periods, so that the wall charge on the data electrodes is replenished. With this structure, voltages of scan pulse voltage Va and address pulse voltage Vd can be set lower.

In the description of the exemplary embodiment, one field is divided into 11 subfields (the first SF, and the second SF through the 11th SF). The respective subfields have luminance weights of 8, 4, 2, 1, 16, 20, 26, 32, 40, 48, and 58 in this order. Further, the first SF through the fourth SF forms a first subfield group in which random driving is performed, using positive-logic addressing. The fifth SF through the 11th SF forms a second subfield group in which successive driving is performed, using negative-logic addressing. However, the subfield structure, including the number of subfields and luminance weights, is not limited to the above. It is preferable to set optimum values according to the characteristics of the panel, specifications of the plasma display device, or the like.

In the description of the exemplary embodiment, sustain pulses are applied to display electrode pairs in the sustain period of each subfield. However, a subfield may be provided so as to have a sustain period in which no sustain pulse is applied. That is, in that sustain period, the wall charge in the discharge cells having undergone an address discharge are erased by application of sustain pulse voltage Vs to scan electrodes SC1 through SCn and 0 (V) to sustain electrodes SU1 through SUn, instead of application of sustain pulses to the display electrode pairs. With this operation, even a dark image can be displayed smoothly.

In the exemplary embodiment, the subfields belonging to the first subfield group are disposed so that the luminance weight is monotonically decreased. Although the present invention is not limited to this structure, the inventors have been verified experimentally that the discharge delay time of the address discharge can be shortened by disposing subfields so that the luminance weight is monotonically decreased.

Next, a description is provided for an example of a driving circuit for generating driving voltage waveforms described in the exemplary embodiment.

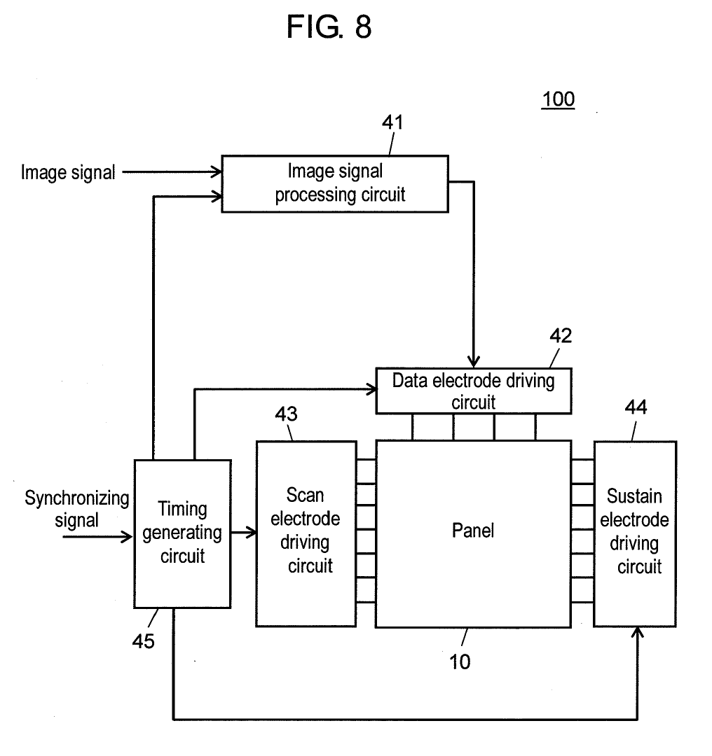

FIG. 8 is a circuit block diagram of plasma display device 100 in accordance with the exemplary embodiment of the present invention. Plasma display device 100 has panel 10 and a panel driving circuit. The panel driving circuit has the following elements:
image signal processing circuit 41;
data electrode driving circuit 42;
scan electrode driving circuit 43;
sustain electrode driving circuit 44;
timing generating circuit 45; and
power supply circuits (not shown) for supplying power necessary for each circuit block.

Image signal processing circuit 41 converts input image signals into image data indicating light emission and no light emission in each subfield. Data electrode driving circuit 42 converts the image data in each subfield into a signal corresponding to each of data electrodes D1 through Dm, and drives each of data electrodes D1 through Dm. Timing generating circuit 45 generates various timing signals for controlling the operation of each circuit block according to a horizontal synchronizing signal and a vertical synchronizing signal, and supplies the timing signals to each circuit block. Scan electrode driving circuit 43 drives each of scan electrodes SC1 through SCn, according to the timing signals. Sustain electrode driving circuit 44 drives sustain electrodes SU1 through SUn, according to the timing signals.

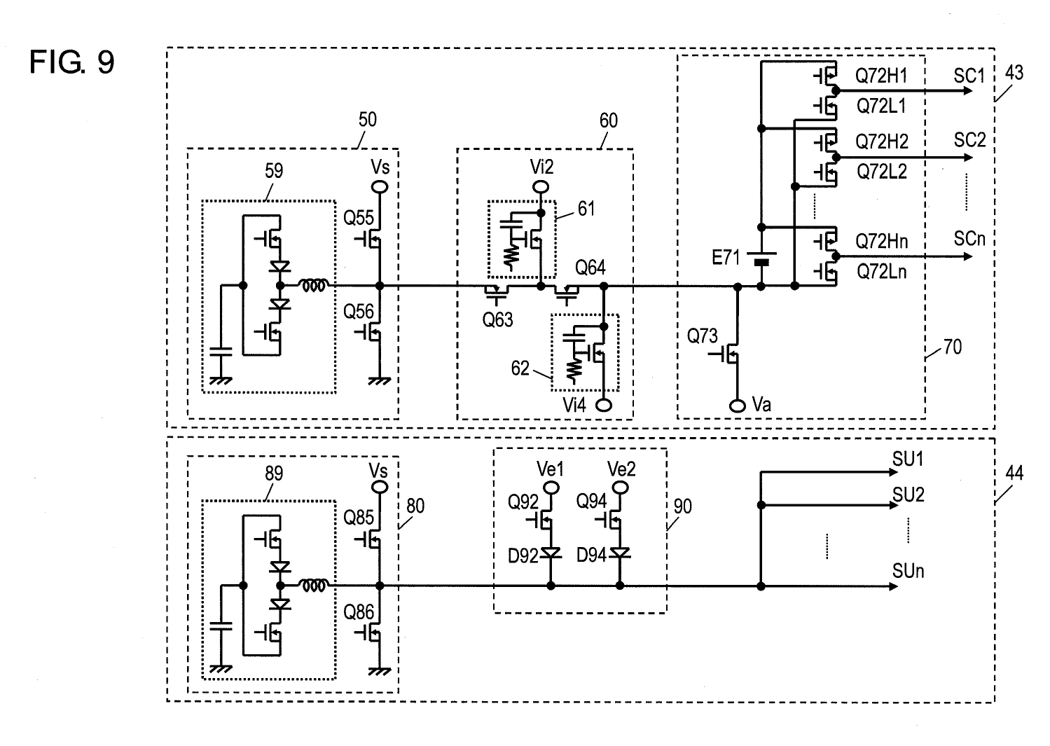

FIG. 9 is a circuit diagram of scan electrode driving circuit 43 and sustain electrode driving circuit 44 of plasma display device 100 in accordance with the exemplary embodiment of the present invention.

Scan electrode driving circuit 43 has sustain pulse generating circuit 50, initializing waveform generating circuit 60, and scan pulse generating circuit 70. Sustain pulse generating circuit 50 has the following elements:
switching element Q55 for applying voltage Vs to scan electrodes SC1 through SCn;
switching element Q56 for applying 0 (V) to scan electrodes SC1 through SCn; and
power recovering section 59 for recovering power when sustain pulses are applied to scan electrodes SC1 through SCn.
   Initializing waveform generating circuit 60 has Miller integrating circuit 61 for applying an up-ramp waveform voltage to scan electrodes SC1 through SCn, and Miller integrating circuit 62 for applying a down-ramp waveform voltage to scan electrodes SC1 through SCn. Switching element Q63 and switching element Q64 are disposed to prevent backflow of current via parasitic diodes, for example, of other switching elements. Scan pulse generating circuit 70 has the following elements:
floating power supply E71;
switching elements Q72H1 through Q72Hn for applying the voltage at the high-voltage side of floating power supply E71 to scan electrodes SC1 through SCn;
switching elements Q72L1 through Q72Ln for applying the voltage at the low-voltage side of the floating power supply to the scan electrodes; and
switching element Q73 for fixing the voltage at the low-voltage side of floating power supply E71 to voltage Va.

Sustain electrode driving circuit 44 has sustain pulse generating circuit 80, and initializing/address voltage generating circuit 90. Sustain pulse generating circuit 80 has the following elements:
switching element Q85 for applying voltage Vs to sustain electrodes SU1 through SUn;
switching element Q86 for applying 0 (V) to sustain electrodes SU1 through SUn; and
power recovering section 89 for recovering power when sustain pulses are applied to sustain electrodes SU1 through SUn.
   Initializing/address voltage generating circuit 90 has the following elements:
switching element Q92 and diode D92 for applying voltage Ve1 to sustain electrodes SU1 through SUn; and
switching element Q94 and diode D94 for applying voltage Ve2 to sustain electrodes SU1 through SUn.

These switching elements can be configured of generally known devices, such as a metal oxide semiconductor field-effect transistor (MOSFET), and an insulated gate bipolar transistor (IGBT). These switching elements are controlled, according to timing signals that are generated in timing generating circuit 45 and correspond to the switching elements.

The driving circuit of FIG. 9 is an example of the circuit configuration for generating the driving voltage waveforms of FIG. 6 and FIG. 7. The plasma display device of the present invention is not limited to this circuit configuration.

The respective specific values for use in the exemplary embodiment are merely examples. It is preferable to set values optimum for the characteristics of the panel, the specifications of the plasma display device, or the like, for each case.

### INDUSTRIAL APPLICABILITY

The plasma display device of the present invention is capable of performing high-speed stable address operation, and displaying images of excellent display quality with smooth gradation and no false contour, and thus is useful as a display device.

1. A plasma display device comprising:
a plasma display panel including:
a front plate having display electrode pairs on a first glass substrate, a dielectric layer disposed so as to cover the display electrode pairs, and a protective layer disposed on the dielectric layer;
a back plate having data electrodes on a second glass substrate, the back plate being faced to the front plate; and
discharge cells formed in positions where the display electrode pairs are faced to the data electrodes; and
a panel driving circuit for driving the plasma display panel in a manner that a plurality of subfields are temporally disposed to form one field period,
wherein the protective layer has:
a base protective layer formed of a thin film of a metal oxide containing at least one of magnesium oxide, strontium oxide, calcium oxide, and barium oxide; and
a particle layer formed by sticking, to the base protective layer, single-crystal particles of magnesium oxide such that an emission intensity of a peak at 200 nm to 300 nm is at least twice an emission intensity of a peak at 300 nm to 550 nm in an emission spectrum of cathode luminescence light emission,
wherein the panel driving circuit drives the plasma display panel in a manner that
a second subfield group having a plurality of subfields is temporally disposed after a first subfield group having a plurality of subfields to form one field period,
each one of the subfields in the first subfield group has an initializing period for forming wall charge to cause an address discharge, an address period for forming wall charge to cause a sustain discharge, and a sustain period for causing a sustain discharge to light the discharge cells, and
each one of the subfield in the second subfield group has an address period for erasing wall charge necessary for causing a sustain discharge, and a sustain period for causing a sustain discharge to light the discharge cells.

2. The plasma display device of claim 1, wherein the panel driving circuit drives the plasma display panel in a manner that
the display electrode pairs are divided into a plurality of display electrode pair groups,
the address period of each one of the subfields belonging to the second subfield group is divided into a plurality of address sub-periods corresponding to the plurality of display electrode pair groups, and
a replenish sub-period for replenishing the wall charge is disposed between one of the address sub-periods and next one of the address sub-periods.
